(19) United States
(12) Patent Application Publication
(10) Pub. No.: US 2024/0226780 A1
(43) Pub. Date: Jul. 11, 2024

(54) Filter

(71) Applicant: 3M INNOVATIVE PROPERTIES COMPANY, St. Paul, MN (US)

(72) Inventor: Takaaki Shirai, Tokyo (JP)

(21) Appl. No.: 18/563,151

(22) PCT Filed: May 31, 2022
(86) PCT No.: PCT/IB2022/055087

§ 371 Date: Nov. 21, 2023

(30) Foreign Application Priority Data
Jun. 2, 2021 (JP) 2021092755

(51) Int. Cl. B01D 29/21; B01D 29/11; B01D 29/23

(52) U.S. Cl. CPC B01D 29/216; B01D 29/111; B01D 29/237; B01D 2201/12; B01D 2201/342

(57) ABSTRACT

A filter (1) includes a filter element (2) having a filter member (10) with a tubular shape disposed on the outer side of a porous tube (7), and the filter member (10) includes an embossed portion (21) formed on a surface of the filter member (10).

### TECHNICAL FIELD

The present invention relates to a filter.

### BACKGROUND

JP 2004-500229 A discloses a known filter. The filter includes a filter element having a filter member with a tubular shape disposed on the outer side of a porous tube.

### SUMMARY

The filter as described in JP 2004-500229 A removes particles contained in liquid passing through the filter member of the filter element. In some cases, to improve the performance of such a filter, calendering may be performed with which the entire surface of the filter member is compressed and crushed. Still, there has been a demand for further improvement in performance over that achieved by such a filter.

Thus, an object of the present invention is to provide a filter that achieves such improvement in performance.

A filter according to an aspect of the present invention includes a filter element having a filter member in a tubular shape disposed on outer side of a porous tube, wherein the filter member has an embossed portion formed on a surface.

With the present invention, a filter that achieves improvement in performance can be provided.

### BRIEF DESCRIPTION OF THE DRAWINGS

FIG. 1 is a perspective view illustrating a filter 1 according to a first embodiment of the present invention.

FIG. 2 is a perspective view of a filter element.

FIGS. 3(a)-3(c) are a view illustrating a lamination mode of the filter element.

FIGS. 4(a)-4(b) are view illustrating a lamination mode of the filter element.

FIGS. 5(a)-5(b) are diagrams illustrating an emboss pattern.

FIG. 6 is a cross-sectional view taken along line VI-VI illustrated in FIG. 5(a).

FIG. 7 is a schematic view illustrating an example of a manufacturing apparatus for manufacturing a laminated sheet.

FIGS. 8(a)-8(c) are schematic views illustrating the behavior of fibers and an opening of the nonwoven fabric.

FIG. 9 is a perspective view illustrating a filter element of a filter according to a second embodiment.

FIGS. 10(a)-10(c) are views illustrating a lamination mode of the filter element.

FIGS. 11(a)-11(b) are enlarged views illustrating a filter element of a filter according to a third embodiment.

FIG. 12 is a table illustrating conditions of filter members used in a test.

FIG. 13 is a table illustrating conditions and test results of the filter member.

FIG. 14 illustrates the relationship between flow rate characteristics and removing performance.

FIG. 15 is a table illustrating conditions and test results of filter members.

FIG. 16 illustrates the relationship between flow rate characteristics and removing performance.

FIG. 17 is a graph illustrating the relationship between a thickness and ventilation resistance.

FIG. 18 is a table illustrating conditions and test results of filter members.

FIG. 19 is a table illustrating conditions and test results of filter members.

FIGS. 20(a)-20(c) are tables illustrating test results.

FIG. 21 is a graph illustrating the relationship between the thickness of a filter member and the outer diameter of a filter element.

FIG. 22 is a graph illustrating the relationship between flow rate and flow rate characteristics.

FIG. 23 is a graph illustrating the relationship between the outer diameter and the flow rate characteristics of the filter element.

FIG. 24 is a graph illustrating the relationship between the outer diameter and the removing performance of the filter element.

FIG. 25 is a graph illustrating the relationship between the outer diameter and the rigidity of the filter element.

### DETAILED DESCRIPTION

Hereinafter, exemplary embodiments of the present invention will be described in detail with reference to the drawings.

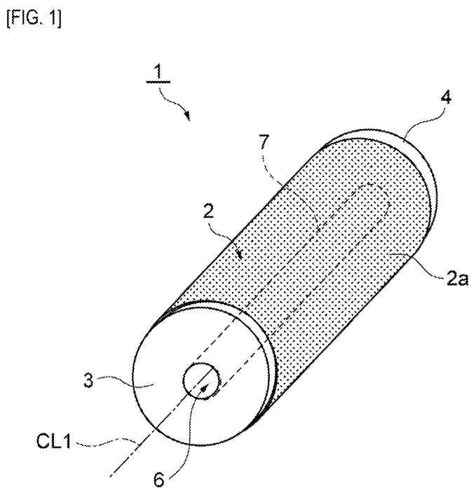

FIG. 1 is a perspective view illustrating a filter 1 according to a first embodiment of the present invention. As illustrated in FIG. 1, filter 1 includes a filter element 2 and gaskets 3 and 4. The filter element 2 is a tubular member and is a member that removes particles contained in liquid. Note that in the following description, a direction in which a central axis CL1 of the filter element 2 extends is referred to as an “axial direction”. A direction orthogonal to the central axis CL1 is referred to as a “radial direction”. Sides toward and away from the central axis CL1 in the radial direction are respectively referred to as an “inner side” and an “outer side”.

A direction around the central axis CL1 is referred to as a “circumferential direction”.

The filter element 2 has a cylindrical interior space 6 formed in the vicinity of the central axis CL1. The filter element 2 removes particles contained in liquid passing through the filter element 2 from the outer side to the inner side in the radial direction, to be introduced into the interior space 6 from an outer circumference surface 2a. Alternatively, the filter element 2 removes particles contained in liquid that has been introduced into the interior space 6, as the liquid passes through the filter element 2 from the inner side to the outer side in the radial direction to be discharged from the outer circumference surface 2a. The gasket 3 is a disk-shaped member provided to cover one end surface of the filter element 2 in the axial direction. The gasket 4 is a disk-shaped member provided to cover the other end surface of the filter element 2 in the axial direction.

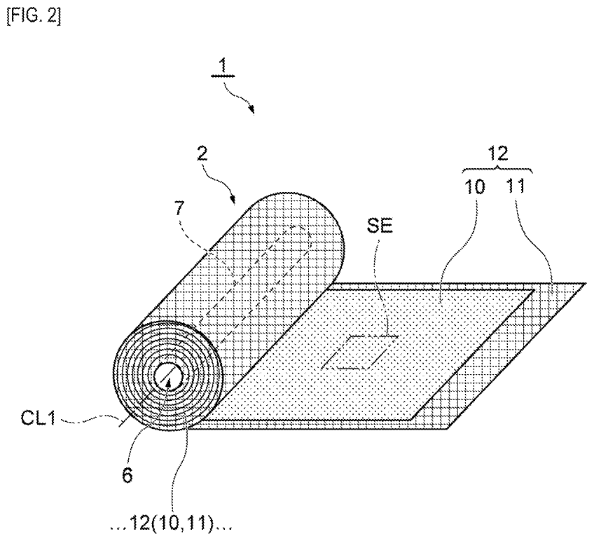

A specific structure of the filter element 2 will be described with reference to FIG. 2 to FIG. 4. As illustrated in FIG. 2, the filter element 2 is configured with a filter member 10 in a tubular shape disposed on the outer side of a porous tube 7. The porous tube 7 is a tubular member serving as a core of the filter element 2. The porous tube 7 has a large number of pores through which liquid passes in the radial direction from the outer circumference surface toward an inner circumference surface or from the inner circumference surface toward the outer circumference surface.

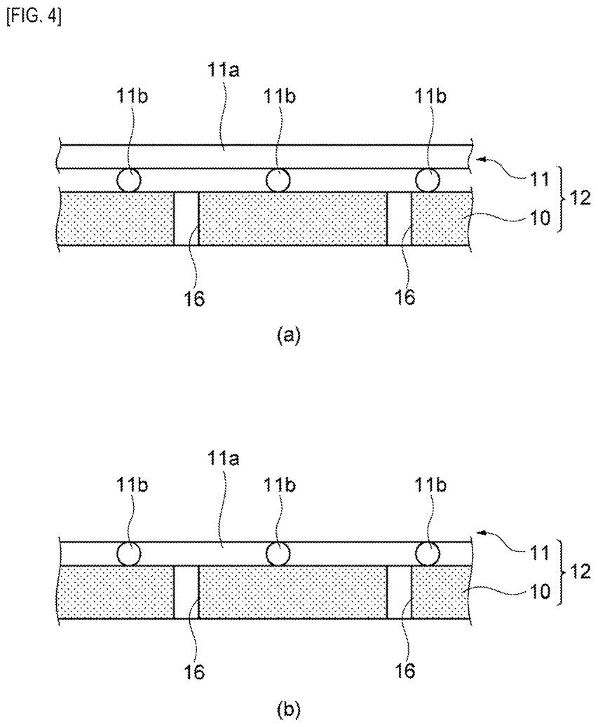

The filter member 10 is disposed on the outer side of the porous tube 7, while being in a tubular shape to surround the outer circumference surface of the porous tube 7 from the outer side. In the present embodiment, the filter member 10 is formed as a sheet-like member. The filter member 10 is wound around the porous tube 7. The filter element 2 includes a wound laminated sheet 12 of the filter member 10 and a net-like substrate 11. The net-like substrate 11 is formed by a plurality of wires 11a and 11b intersecting each other (see FIGS. 4(a) and 4(b)).

Note that the wire 11a and the wire 11b may be stacked one on top of the other (see FIG. 4(a)), or may be disposed on the same plane (see FIG. 4(b)). FIG. 2 illustrates a state where the outermost laminated sheet 12 is unwound and laid flat. The laminated sheet 12 is formed by disposing a sheet-like filter member 10 on the main surface on one side of the substrate 11 having an elongated strip shape. On the substrate 11, a plurality of the filter members 10 may be arranged side by side in a longitudinal direction (winding direction). Alternatively, the filter member 10 may be formed to have an elongated strip shape similar to that of the substrate 11.

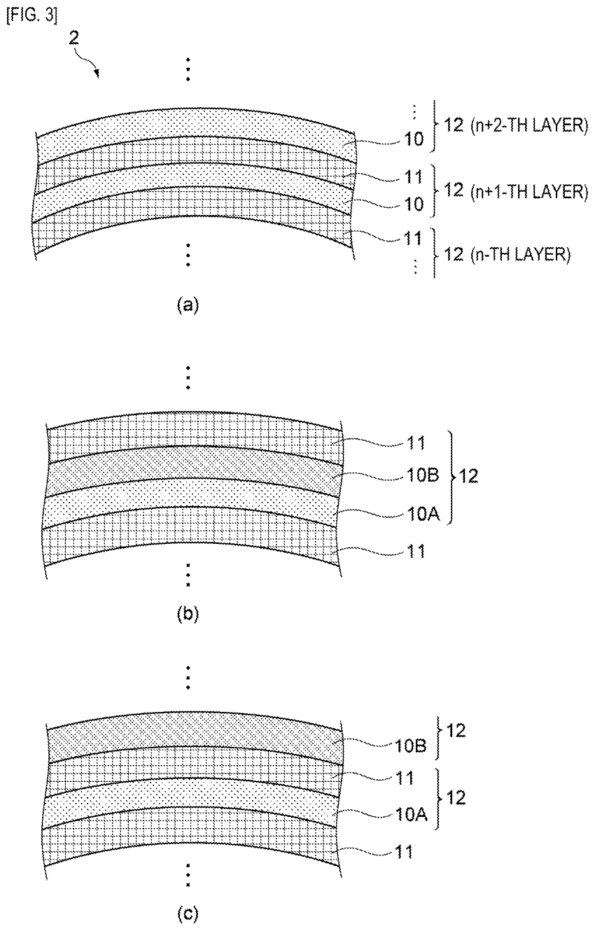

FIG. 3(a) is an enlarged view of the laminated sheet 12 described above after being wound. FIG. 3(a) illustrates a lamination mode of the laminated sheet 12 at an end surface of the filter element 2 in the axial direction. As illustrated in FIG. 3(a), in the filter element 2, the filter member 10 and the substrate 11 are alternately laminated in the radial direction. Specifically, the winding is performed to make the inner circumference surface of the filter member 10 of the “n+1-th” layer of the laminated sheet 12 from the central axis be in contact with the outer circumference surface of the substrate 11 of the “n-th” layer of the laminated sheet 12. Furthermore, the winding is performed to make the inner circumference surface of the filter member 10 of the “n+2-th” layer of the laminated sheet 12 from the central axis be in contact with the outer circumference surface of the substrate 11 of the “n+1-th” layer of the laminated sheet 12. Note that each laminated sheet 12 may have a member other than the substrate 11 and the filter member 10 that is laminated. Furthermore, a plurality of the filter members 10 may be laminated on the substrate 11 of each laminated sheet 12. For example, the filter member 10 may be laminated on both main surfaces of the substrate 11.

In the filter element 2, a plurality of the filter members 10 having the same ventilation resistance may be layered in the radial direction and wound. Alternatively, in the filter element 2, a plurality of the filter members 10 having different ventilation resistances may be layered in the radial direction and wound. For example, as illustrated in FIG. 3(b) and FIG. 3(c), a filter member 10A disposed on the inner side in the radial direction and a filter member 10B disposed on the outer side in the radial direction may have different ventilation resistances. For example, as illustrated in FIG. 3(b), each laminated sheet 12 may include the filter members 10A and 10B having different ventilation resistances. In this case, the laminated sheet 12 is formed with the filter members 10A and 10B, having different ventilation resistances, laminated on the substrate 11 before winding. Alternatively, as illustrated in FIG. 3(c), the filter member 10A of the laminated sheet 12 on the inner side in the radial direction and the filter member 10B of the laminated sheet 12 on the outer side may have different ventilation resistances. The ventilation resistance may gradually decrease from the outer side toward the inner side in the radial direction. Alternatively, the ventilation resistance may gradually increase from the outer side toward the inner side in the radial direction. Note that in the example illustrated in FIG. 3(b) and FIG. 3(c), a region illustrated as the “filter member 10A” is not limited to a case of being formed by a single sheet of the filter member 10A, and the filter member 10A may be formed by laminating a plurality of sheets with the same ventilation resistance. The same applies to a region illustrated as the “filter member 10B”.

As illustrated in FIG. 4(a), the filter member 10 may have pores 16. The pore 16 is formed through the filter member 10 in the radial direction between the surface on the inner side and the surface on the outer side. The size and arrangement of the pores 16 are not particularly limited. Still, the diameter of the pore 16 may be set to approximately 3.97 mm ( 5/32 inches). Furthermore, the pores 16 may be arranged on a straight line at an interval of about 30.5 mm (1.2 inches). Furthermore, the pores 16 on one straight line and the pores 16 on an adjacent straight line are alternately arranged. The interval between the straight lines may be set to about 15.2 mm (0.6 inches).

Next, a material of the filter member 10 will be described. A material that can remove particles from liquid passing therethrough is used as the material of the filter member 10. A nonwoven fabric is used as the material of the filter member 10, for example. The basis weight of the nonwoven fabric may be set to 10 to 1000 gsm. A thermoplastic resin such as polypropylene, polyethylene, polyester, nylon, or the like may be employed as the nonwoven fabric material. Alternatively, a material (such as woven fabric or paper, for example) enabling filtration by means of a void formed by fibers may be employed as the filter member 10.

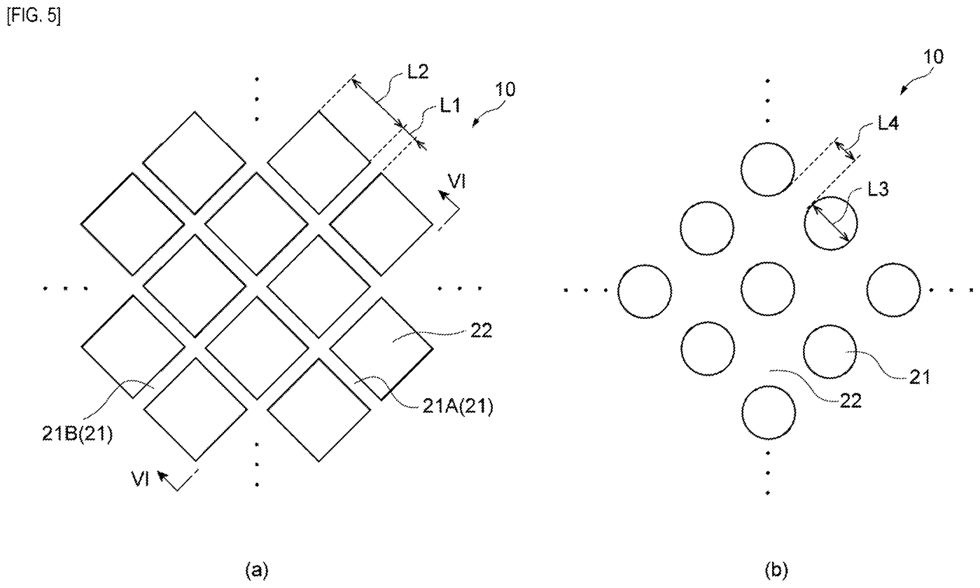

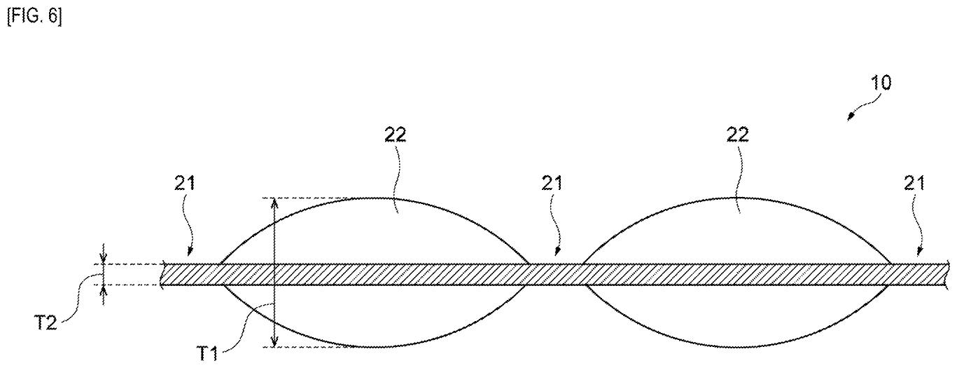

Next, a detailed configuration of the filter member 10 will be described with reference to FIG. 5 and FIG. 6. FIG. 5 is an enlarged plan view illustrating a state of a surface of the filter member 10. FIG. 6 is a cross-sectional view taken along line VI-VI in FIG. 5(a). As illustrated in FIG. 5(a) and FIG. 5(b), the filter member 10 has an embossed portion 21 (compressed portion) formed on the surface. Note that a portion other than the embossed portion 21 is referred to as a non-embossed portion 22 (non-compressed portion).

As illustrated in FIG. 5, the embossed portion 21 is a portion obtained by performing partial thinning process on part of a base material (the nonwoven fabric before the process) of the filter member 10. Such an embossed portion 21 is formed by thermocompression on the base material of the filter member 10 using an embossing roll or the like. The filter member 10 has the embossed portion 21 on both surfaces in a thickness direction. Although not particularly limited, a thickness T2 of the embossed portion 21 may be set to 1% or greater, 5% or greater, 10% or greater, or 20% or greater of a thickness T1 of the non-embossed portion 22 (that is, the thickness of the filter member 10) that is defined as 100%. Furthermore, the thickness T2 of the embossed portion 21 may be set to 70% or less, 65% or less, 60% or less, or 50% or less. The thickness T1 of the filter member 10, which is not particularly limited, may be set to be in a range from 0.1 to 15 mm.

FIG. 5(a) and FIG. 5(b) each illustrate an example of a type of an emboss pattern of the embossed portion 21. In the emboss pattern in FIG. 5(a), the non-embossed portions 22 have a predetermined shape to form a closed region, and the embossed portion 21 is formed in a region of a gap between the non-embossed portions 22. In the example illustrated in FIG. 5(a), the non-embossed portion 22 has a square shape. The embossed portion 21 is formed between one side of the square non-embossed portion 22 and one side of the adjacent non-embossed portion 22. The embossed portion 21 is linearly formed along a plurality of the non-embossed portions 22. Such an emboss pattern includes linear first embossed portions 21A arranged to be spaced apart at a constant pitch, and linear second embossed portions 21B arranged to be spaced apart at a constant pitch and to be orthogonal to the first embossed portions 21A.

Note that a width L1 of the embossed portion 21, the dimensions of which are not particularly limited, may be set to 0.1 mm or greater, 0.2 mm or greater, or 0.3 mm or greater. The width L1 of the embossed portion 21 may be set to be 5 mm or less, 3 mm or less, or 1 mm or less. A length L2 of one side of the non-embossed portion 22 may be set to be 0.5 mm or greater, 1.0 mm or greater, 1.5 mm or greater, or 2.0 mm or greater. The length L2 of one side of the non-embossed portion 22 may be set to be less than 99.9 mm, 50 mm or less, 30 mm or less, or 10 mm or less. Note that the shape of the non-embossed portion 22 is not particularly limited, and may be a triangle, a polygon with five or more sides, or a shape with a longitudinal direction such as a rectangle.

In the emboss pattern in FIG. 5(b), the embossed portion 21 have a predetermined shape to form a closed region, and the non-embossed portion 22 is formed in a region of gaps between the embossed portions 21. In the example illustrated in FIG. 5(b), the embossed portion 21 has a circular shape. The non-embossed portion 22 is formed between the embossed portion 21 and the adjacent embossed portion 21. Note that a diameter L3 of the embossed portion 21, the dimensions of which are not particularly limited, may be set to 0.1 mm or greater, 0.3 mm or greater, 0.5 mm or greater, or 1 mm or greater. The diameter L3 of the embossed portion 21 may be set to 20 mm or less, 15 mm or less, 10 mm or less, or 5 mm or less. A pitch L4 between the embossed portions 21 (that is the width of the non-embossed portion 22) may be set to be 0.5 mm or greater, 1 mm or greater, or 2 mm or greater. The pitch L4 of the embossed portion 21 may be set to 10 mm or less, 8 mm or less, or 5 mm or less. The embossed portions 21 are arranged according to a predetermined arrangement pattern. The shape of the embossed portion 21 is not particularly limited, and may be a polygon or a shape having a longitudinal direction such as an oval or an ellipse.

The proportion of the total area of the embossed portions 21 per unit area of the filter member 10 may be greater than 0% and less than 44%. More preferably, the proportion of the area of the embossed portions 21 per unit area of the filter member 10 is greater than 0%, and may be 2% or greater or 5% or greater and be 35% or less, 25% or less, or 16% or less. Note that, as illustrated in FIG. 2, a unit region SE is (virtually) set. The unit region SE can be set as a rectangle with each side being 100 mm long, for example. The unit region SE set to any position of the filter member 10 includes the plurality of embossed portions 21 and non-embossed portions 22 according to a predetermined emboss pattern, with the proportion of the area of the embossed portions 21 being within the range described above. Such a relationship preferably holds wherever the unit region SE may be (virtually) moved in the filter member 10. For example, a configuration where the embossed portion 21 having a wide area is formed in a part of the filter member 10 and the non-embossed portion 22 of a wide range is formed in another part, may result in the proportion of the area of the embossed portions 21 per unit area being within the range described above. However, in such a configuration where the embossed portions 21 are concentrated, movement of the unit region SE results in a portion where the unit region SE is entirely occupied by the embossed portion 21 or the non-embossed portion 22. Thus, with the configuration where the embossed portion 21 is thus concentrated in a certain part, the filter member 10 has uneven filtering performance. On the other hand, when the embossed portions 21 are formed according to a predetermined emboss pattern, the filtering performance of the filter member 10 can be prevented from being uneven.

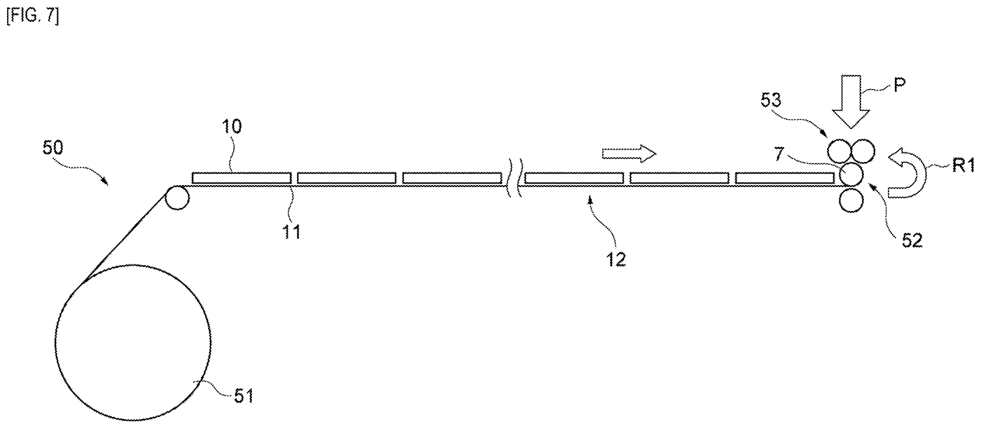

Next, a method for manufacturing the filter element 2 will be described with reference to FIG. 7. FIG. 7 illustrates a manufacturing apparatus 50 for the filter element 2. The manufacturing apparatus 50 includes a feed roller 51 that feeds the substrate 11, a winding unit 52 that winds the laminated sheet 12, and a compression unit 53 that compresses the laminated sheet 12 wound. First of all, the feed roller 51 feeds the substrate 11 to the winding unit 52. At an intermediate position of a conveyance path, the filter member 10 is disposed on the substrate 11. The winding unit 52 rotates the porous tube 7 in a rotational direction R1, to wind the laminated sheet 12 with the porous tube 7. In this process, the compression unit 53 applies pressure P onto the laminated sheet 12 wound, from the outer side. As a result, the laminated sheet 12 is wound around the porous tube 7 for a predetermined number of times, whereby the filter element 2 is completed.

Next, actions and effects of the filter 1 according to the present embodiment will be described.

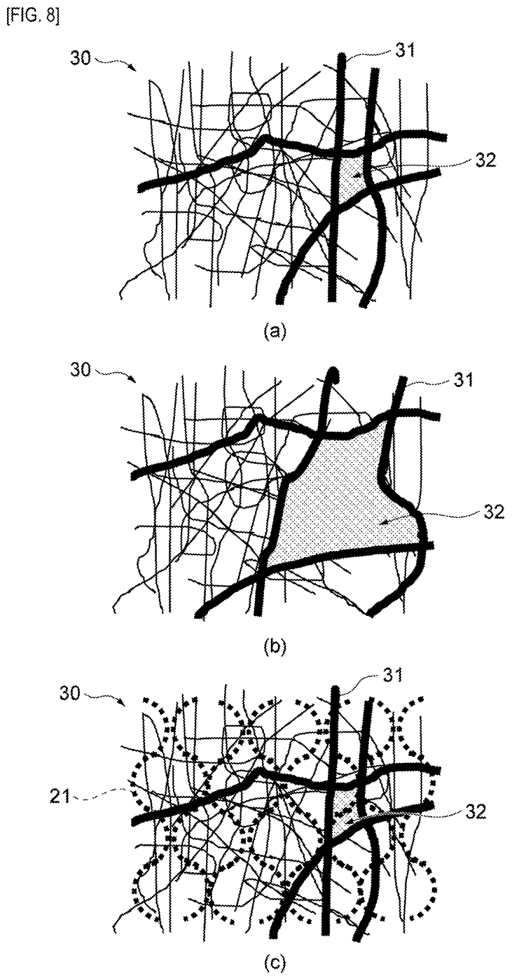

For a filter using a nonwoven fabric or the like as a filter member, a nonwoven fabric with a smaller fiber diameter may be used for the sake of improvement in the particle removing performance. For example, in a nonwoven fabric 30 as illustrated in FIG. 8(a) has an opening 32 formed between the plurality of fibers 31. Note that in FIG. 8, the opening 32 used for the description is shaded, and bold lines represent the fibers 31 defining the opening 32. In such a nonwoven fabric, with finer fibers 31, a smaller opening 32 can be obtained. However, this requires fine fiber nonwoven manufacturing, employing electrospinning or the like, which is unfavorable in terms of productivity and cost.

As another way of improving the particle removing performance with a smaller opening 32, the nonwoven fabric may be crushed by calendering for compressing the entire surface of the filter member. However, this results in compromised flow rate characteristics. Furthermore, the position of the calendered nonwoven fabric is not maintained, meaning that the fibers 31 are flowable. Thus, as illustrated in FIG. 8(b), the opening 32 can expand due to stress generated when the fluid passes. In that case, the particles may pass through the opening 32, and thus the removing performance may be compromised. To address this, the calendering may be performed under a high temperature condition to densely form the openings 32. However, this results in the surface of the nonwoven fabric being melted, leading to excessively densely formed openings 32 or even elimination of the openings 32, resulting in the nonwoven fabric being unable to function as a filter.

In view of this, the filter 1 according to an aspect of the present embodiment includes the filter element 2 having the filter member 10 in a tubular shape disposed on the outer side of the porous tube 7, wherein the filter member 10 has a surface on which the embossed portion 21 is formed.

In this case, as illustrated in FIG. 8(c), the embossed portion 21 formed entirely over the nonwoven fabric 30 maintains the positions of the fibers 31 of the nonwoven fabric. Thus, the mobility of the fibers 31 can be reduced from that in the case of the calendered nonwoven fabric. Accordingly, when a fluid passes through the filter member 10, the diameter of the opening 32 can be maintained favorably despite the stress of the fluid. Therefore, the removing performance of the filter element can be improved from that in the case of the calendered nonwoven fabric. Furthermore, the flow rate characteristics can be improved from that in the case of the calendered nonwoven fabric.

The filter member 10 is a sheet-like member, and may be wound around the porous tube 7. In this case, filtration can be performed by the liquid passing through the filter member 10 wound around the porous tube 7.

The filter element 2 may include the wound laminated sheet 12 of the filter member 10 and the net-like substrate 11. In this case, the filter member 10 can be supported by the substrate 11. The substrate 11 in such a configuration can effectively guarantee the strength when a member other than the filter member 10 is included in the laminated sheet 12.

In the filter element 2, a plurality of the filter members 10 having different ventilation resistances may be layered in the radial direction and wound. In this case, foreign matters of different particle sizes contained in the liquid are efficiently captured so that effective removal of foreign matters from the liquid with a wide particle size distribution is enabled, and the service life of the filter can be improved.

The filter member 10 may have the pores 16. In this case, part of the liquid passes through the pore 16 of the filter member 10 to facilitate the distribution of the liquid over the entire surface of the filter member 10, and the service life of the filter can be improved.

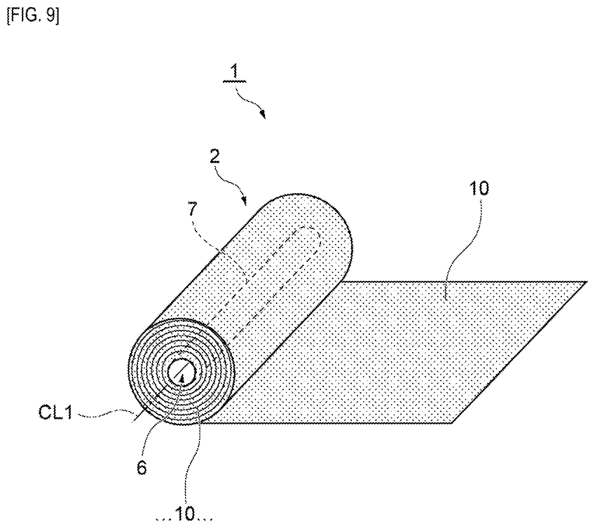

Next, a filter 1 according to a second exemplary embodiment will be described with reference to FIG. 9. The filter 1 according to the second embodiment differs from the filter 1 according to the first embodiment in that the filter element 2 does not include the substrate 11. Note that the filter element 2 according to the second embodiment has the same configuration as the filter element 2 according to the first embodiment, except that the substrate 11 is not provided. Thus, the filter member 10 and the porous tube 7 described in the first embodiment can be similarly employed in the filter element 2 according to the second embodiment.

As illustrated in FIG. 9, the filter member 10 of the filter element 2 is a sheet-like member, and is wound around the porous tube 7. Here, the filter member 10, formed into an elongated strip shape, alone is wound around the porous tube 7.

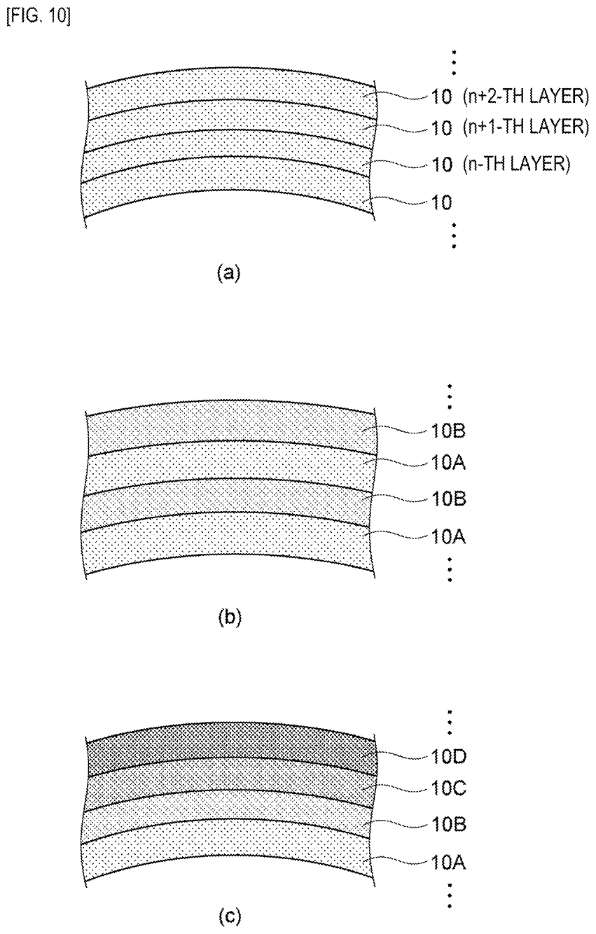

FIG. 10 is an enlarged view illustrating a state after the filter member 10 described above is wound. FIG. 10 illustrates a lamination mode of the filter member 10 at an end surface of the filter element 2 in the axial direction. As illustrated in FIG. 10(a), in the filter element 2, the filter members 10 are continuously laminated in the radial direction. Specifically, the winding is performed to make the inner circumference surface of the “n+1-th” layer of the filter member 10 from the central axis be in contact with the outer circumference surface of the “n-th” layer of the filter member 10. The winding is performed to make the inner circumference surface of the “n+2-th” layer of the filter member 10 from the central axis be in contact with the outer circumference surface of the “n+1-th” layer of the filter member 10.

As illustrated in FIG. 10(a), in the filter element 2, a plurality of the filter members 10 having the same ventilation resistance may be layered in the radial direction and wound. Alternatively, in the filter element 2, a plurality of the filter members 10 having different ventilation resistances may be layered in the radial direction and wound. For example, as illustrated in FIG. 10(b) and FIG. 10(c), a filter member 10 disposed on the inner side in the radial direction and a filter member 10 disposed on the outer side in the radial direction may have different ventilation resistances. For example, as illustrated in FIG. 10(b), combinations each including the filter members 10A and 10B having different ventilation resistances may be continuously arranged in the radial direction. In this case, before the winding, the filter members 10A and 10B having different ventilation resistances are laminated in advance, and the filter members 10A and 10B thus laminated are wound around the porous tube 7. Alternatively, as illustrated in FIG. 10(c), filter members 10A, 10B, 10C, and 10D having different ventilation resistances may be wound to make the ventilation resistance vary among positions in the radial direction. In this case, before the winding, the filter member 10 having an elongated strip shape may be formed by connecting, in the longitudinal direction, the filter members 10A, 10B, 10C, and 10D having different ventilation resistances. Note that in the example illustrated in FIG. 10(b) and FIG. 10(c), a region illustrated as the “filter member 10A” is not limited to a case of being formed by a single sheet, and the filter member 10A may be formed by laminating a plurality of sheets with the same ventilation resistance. The same applies to regions illustrated as the “filter members 10B, 10C, and 10D”.

Now, a case is described where a known filter element is made using a nonwoven fabric without embossing or calendering, and with the net-like substrate 11 omitted. With this configuration, when the filter element is used under a condition where a load on the filter is high such as high temperature and mid to high flow rate, problems due to insufficient rigidity and durability of the outermost layer surface of the filter element arise, such as compromised flow rate characteristics and collapsing of the nonwoven fabric as the surface due to the deformation of the filter element. In order to solve such problems, the calendering may be performed on the nonwoven fabric to improve the rigidity and the durability of the filter element. However, such a method improves the rigidity and the durability but also increases the density because the nonwoven fabric is crushed, resulting in compromised flow rate characteristics. Furthermore, the outer diameter of the filter element is reduced, and this may ruin the desired balance between the removing performance and the flow rate characteristics of the filter.

To address this, in the filter 1 according to the second embodiment in which the substrate 11 is omitted, the filter member 10 including the embossed portion 21 is continuously laminated in the radial direction. With this configuration, the embossed portion 21 reinforces the filter member 10 and thus can improve the rigidity and durability of the filter element. Furthermore, the flow rate characteristics and the removing performance can be improved, as described in the first embodiment.

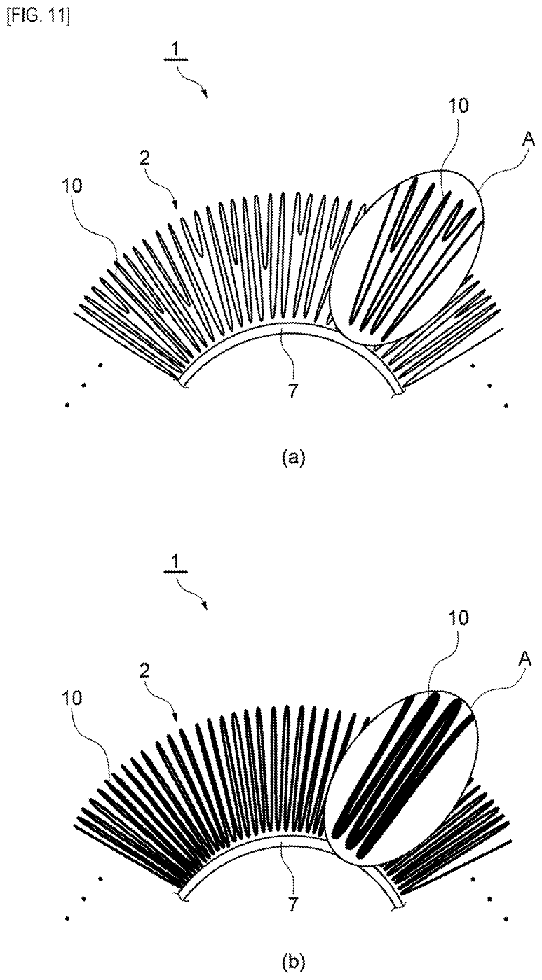

Next, a filter 1 according to a third exemplary embodiment will be described with reference to FIG. 11(a) and FIG. 11(b). The filter 1 according to the third embodiment differs from the filter 1 according to the first embodiment in that the filter member 10 being a sheet-like member is not wound around the porous tube 7. Note that the filter element 2 according to the third embodiment includes the filter member 10 having a shape different from that in the first embodiment. In the filter 1 according to the third embodiment, a porous cage may be provided on the outer circumference of the filter member 10. The filter member 10 may be used while being laminated with a reinforcing member such as a net member such as the substrate 11 or other nonwoven fabric materials with high rigidity. Thus, a material that is the same as the filter member 10 described in the first embodiment may be used as the filter member 10 in the filter element 2 of the third embodiment. Furthermore, the porous tube 7 that is the same as that described in the first embodiment may be used.

As illustrated in FIG. 11(a) and FIG. 11(b), in the filter 1 according to the third embodiment, the filter member 10 is disposed on the outer side of the porous tube 7 in the radial direction, the filter member being folded into a pleated shape. FIG. 11(a) and FIG. 11(b) are diagrams illustrating the filter 1 as viewed in the axial direction, and in the diagrams, part of the filter 1 in the circumferential direction is enlarged. The pleated shape corresponds to a state where the sheet-like filter member 10 is folded in a corrugated shape as viewed in the axial direction, as can be seen in enlarged part “A” of the filter element 2 in FIG. 11(a) and FIG. 11(b). The filter member 10 extends outward in the radial direction, folded to extend inward, and then is folded again to extend outward. The shape with such folding repeated over the entirety in the circumferential direction is obtained. As a result, the filter member 10 is formed as a tubular filter element 2 having a predetermined thickness in the radial direction. With the porous tube 7 inserted in the center space of the filter element 2, a configuration where the filter member 10 is disposed on the outer side of the porous tube 7 is obtained. Note that the folding mode of the filter member 10 is not particularly limited. As illustrated in FIG. 11(a), there may be a portion in which the filter member 10 is folded randomly. As illustrated in FIG. 11(b), the filter member 10 may be regularly folded over the entirety.

### Examples

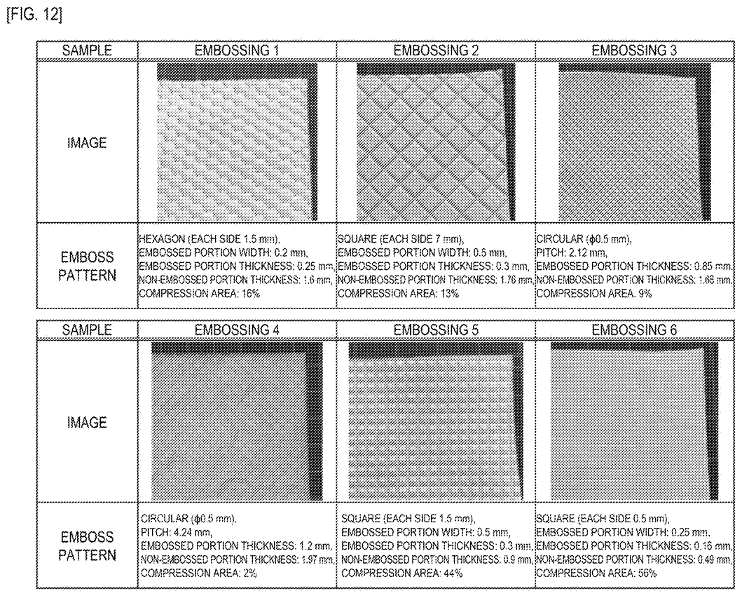

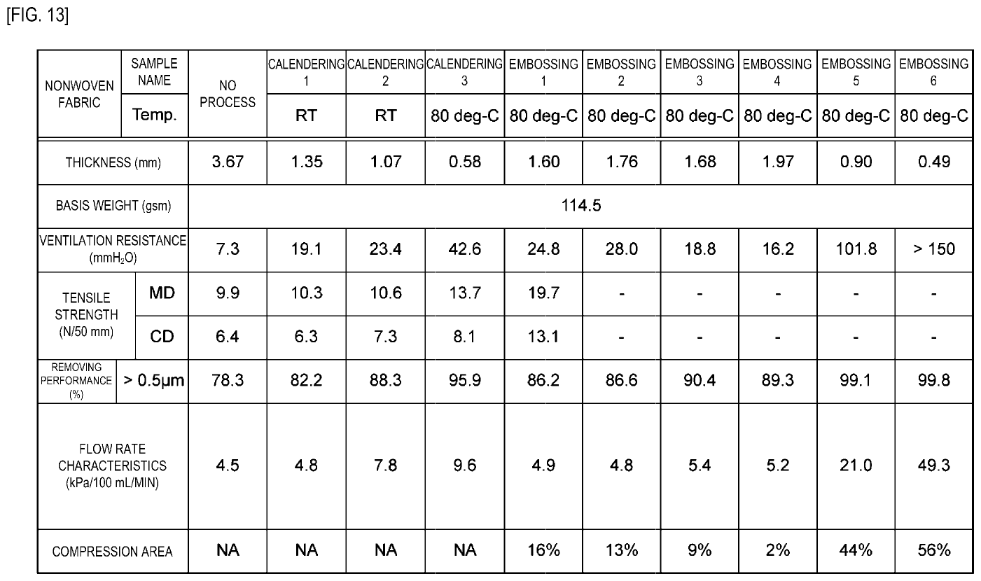

Hereinafter, examples will be described. First, as a filter member for use in the examples, six types of filter members of nonwoven fabrics each having an emboss pattern including an embossed portion and a non-embossed portion were prepared. The emboss patterns of six types of filter members are listed in FIG. 12 as “embossing 1 to embossing 6”. The top row of the field “emboss pattern” describes the shape of the emboss pattern. The embossing 1, embossing 2, embossing 5, and embossing 6 are patterns each having a polygonal non-embossed portion. The embossing 3 and embossing 4 are patterns each having a circular embossed portion. Note that the proportion of the total area of the embossed portion per unit area is indicated as “compression area”. Note that other features of the embossing 1 to embossing 6 are described in FIG. 13. For example, “Temp.” indicates the heating temperature of the embossing roll during embossing. The “basis weight” indicates the mass per unit area of the filter member. Note that the following method was employed as a method for measuring “thickness”. Samples were cut out to have a size of 25 cm×20 cm and left to stand for one hour. Subsequently, the samples were sandwiched between flat plates with force applied thereto with the total load of 14 grams being applied from above, and the distance between the plates was measured, using a dial indicator, as the thickness. The following method was employed as a method for measuring the “basis weight”. The samples cut out to have a size of 25 cm×20 cm were measured with a mass meter, and the weight per square meter was calculated as the basis weight.

In addition, as filter members for use in comparative examples, three types of filter members of nonwoven fabrics provided with calendering were prepared.

Features of these filter members are listed in “calendaring 1 to calendaring 3” in FIG. 13. In addition, as the filter members for use in the comparative examples, a nonwoven fabric provided with neither calendering nor embossing was prepared. Features of this filter member are listed in “no process” in FIG. 13.

First, the performance of each filter member alone was evaluated before the filter member was used for assembling a filter. The “ventilation resistance” indicates ventilation resistance evaluation results. In this evaluation test, air was flowed toward the samples of the filter members at an air flow rate of 32 L/min, and measurement was made according to the evaluation test method defined in ASTM F778-88. The “tensile strength” indicates results of a tensile test performed. The “MD” indicates tensile strength evaluation results in the roll winding direction in the manufacturing of the nonwoven fabric, and the “CD” indicates tensile strength evaluation results in the roll width direction in the manufacturing of the nonwoven fabric. This tensile strength test was performed as follows. First, nonwoven fabric samples were cut out to have a size of 5 cm×25 cm. The samples were chucked with the distance between chucks being 20 cm. Next, the samples were each pulled with a tensile tester at a tensile speed of 200 mm/min, and the maximum breaking strength obtained in this process was defined as the tensile strength.

The “flow rate characteristics” in FIG. 13 indicate results of evaluating the liquid passing resistance of each sample as the flow rate characteristics. The “removing performance” in FIG. 13 indicates evaluation results of filtration accuracy. For the measurement of these evaluation results, four steps of “(1) Preparation of disk samples and setting in housing”, “(2) Hydrophilic treatment”, “(3) Measurement of flow rate characteristic (liquid passing resistance)”, and “(4) Measurement of removing performance” were performed in succession. In “(1) Preparation of disk samples and setting in housing”, a nonwoven fabric of a filter member was punched into a disk shape of @47 mm. Disk samples were overlaid one on top of the other with the total mass of the disk samples being in a range from 1.7 to 1.9 mm. The overlaid disk samples were set in a disk holder. In “(2) Hydrophilic treatment”, a hydrophilic treatment was performed with ultrapure water passed into the disk holder. The outlet side in the liquid passing step was sealed, and then this state was maintained for 10 minutes under a pressure of 0.1 MPa. Then, the outlet side in the liquid passing step was opened, and the liquid was passed at 0.1 MPa for 5 minutes. In “(3) Measurement of flow rate characteristic (liquid passing resistance)”, the ultrapure water was passed at a flow rate in the range from 10 to 100 mL/min after the hydrophilic treatment, and the liquid passing resistance with a 100-mL/min liquid-passing conversion value was determined from the relationship between the differential pressure and the flow rate during the passing of the ultrapure water. This liquid passing resistance was determined as the flow rate characteristic. In “(4) Measurement of removing performance”, fumed silica (OX50, available from Evonik) was added to a colloidal silica solution (PL2, available from Fuso Chemical Co., Ltd.) at a concentration of 100 ppm, and thus a challenge liquid was adjusted. The challenge liquid was passed through the disk samples at a flow rate of 100 mL/min, and the filtrate was sampled after 210 seconds. The numbers of particles contained in undiluted solution and filtrate samples was measured with a particulate counter Accusizer (registered trademark) FX-Nano (available from Nihon Entegris GK), to measure the removing performance. Note that the removing performance was calculated based on “Removing performance=[(Number of particles contained in undiluted solution sample−Number of particles contained in filtrate sample)/Number of particles contained in undiluted solution sample]×100”. Hereinafter, the same calculation applies to the description on the measurement of the removing performance.

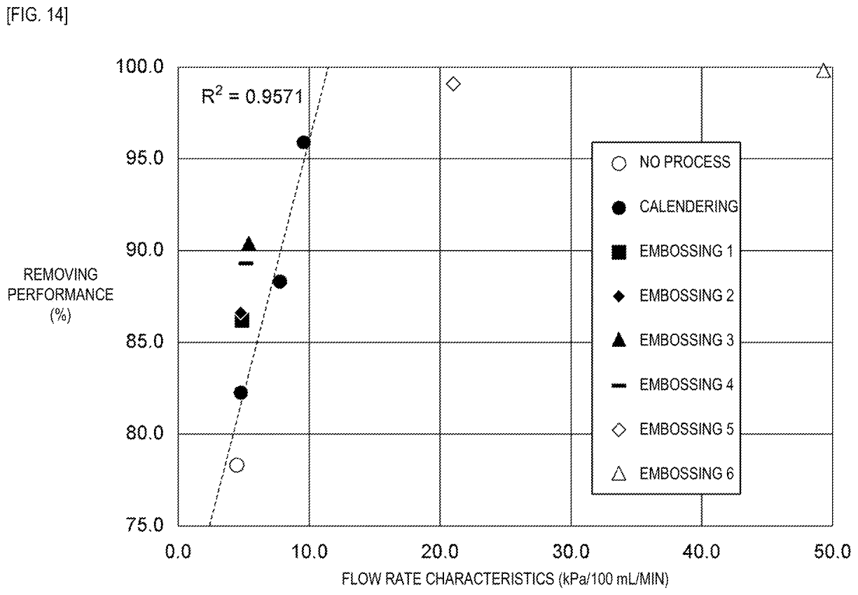

FIG. 14 illustrates the relationship between the flow rate characteristic and the removing performance. It can be seen that the embossing 1 to embossing 4, with the proportion of the area of the embossed portion being less than 44%, achieved higher removing performance than “no process” and “calendering” with the same level of liquid passing resistance. From this result, it has been confirmed that the removing performance of any of the filters of the first to the third embodiments described above was improved by using the filter member having the embossed portion.

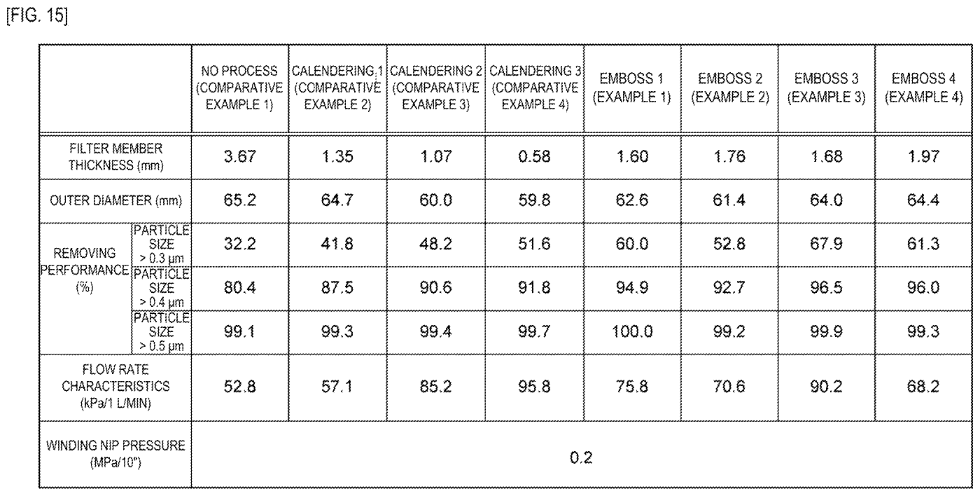

Next, a filter of the type corresponding to the first embodiment as illustrated in FIG. 2 was created. A filter using a filter member with “no process” was defined as Comparative Example 1, filters using filter members with “calendaring 1 to calendaring 3” were defined as Comparative Examples 2 to 4, and filters using filter members with “embossing 1 to embossing 4” were defined as Examples 1 to 4. Note that for any of the comparative examples and examples, the manufacturing apparatus for the filter element illustrated in FIG. 7 was used. For all the examples and the comparative examples, the same conditions were used except for the filter member used. The feed speed of the laminated sheet was 120 (mm/sec), and the nip pressure during winding was 0.2 (MPa/10 inches). Note that 10 filter members were arranged in the longitudinal direction on the net-like substrate. Specifically, filter members each corresponding to one of embossing 1 to embossing 4 were arranged as the first to the ninth filter members from the porous tube 7, and a filter member made of a nonwoven fabric with the basis weight of 100 gsm and the ventilation resistance of 4.5 mm H₂O was arranged as the farthest filter member (that is, the 10th) from the porous tube 7. As a result of winding with the filter members thus arranged, a filter element was obtained that includes the filter members with embossing 1 to embossing 4 as the first to the ninth filter members from the inner side of the filter element and the filter member made of the nonwoven fabric as described above as one filter member on the outer side. The winding termination was welded by thermal welding. The diameters of these filter elements are listed in the field “outer diameter” in FIG. 15.

In FIG. 15, “flow rate characteristics” and “removing performance” respectively indicate the evaluation result of the flow rate characteristics of each filter element and the evaluation result of the removing performance of each filter. For the measurement of these evaluation results, four steps of “(1) Preparation of 2-inch cartridge samples and setting in housing”, “(2) Hydrophilic treatment”, “(3) Measurement of flow rate characteristic (liquid passing resistance)”, and “(4) Measurement of removing performance” were performed in succession. In “(1) Preparation of 2-inch cartridge samples and setting in housing”, the filter element was cut to be 2 inches long and assembled into a 2-inch cartridge. The cartridge was set in the housing. In “(2) Hydrophilic treatment”, a hydrophilic treatment was performed with ultrapure water filled. Then, the outlet side in the liquid passing step was sealed, and then this state was maintained under a pressure of 0.1 MPa for 10 minutes. Then, the outlet side in the liquid passing step was opened, and the liquid was passed at 0.1 MPa for 5 minutes. In “(3) Measurement of flow rate characteristic (liquid passing resistance)”, the ultrapure water was passed at a flow rate in the range of 100 to 500 mL/min after the hydrophilic treatment, and the liquid passing resistance with a 1-L/min liquid-passing conversion value was determined from the relationship between the differential pressure and the flow rate during the passing of the ultrapure water. This liquid passing resistance was determined as the flow rate characteristic. Then, in “(4) Measurement of removing performance”, fumed silica (OX50, available from Evonik) was added to a colloidal silica solution diluted 10-fold with ultrapure water (PL2, available from Fuso Chemical Co., Ltd.) at a concentration of 100 ppm, and thus a challenge liquid was adjusted. The challenge liquid was passed through the cartridge at a flow rate of 350 mL/min, and the filtrate was sampled after 210 seconds. The numbers of particles contained in undiluted solution and filtrate samples was measured with a particulate counter Accusizer (registered trademark) FX-Nano (available from Nihon Entegris GK), to measure the removing performance. Note that in FIG. 15, the particle size is classified into >0.3 μm, >0.4 μm, and >0.5 μm. The classifications respectively indicate the removing performance for particle sizes of >0.3 μm, >0.4 μm, and >0.5 μm. The embossed sample can further remove particles smaller than those removable by the calendered sample.

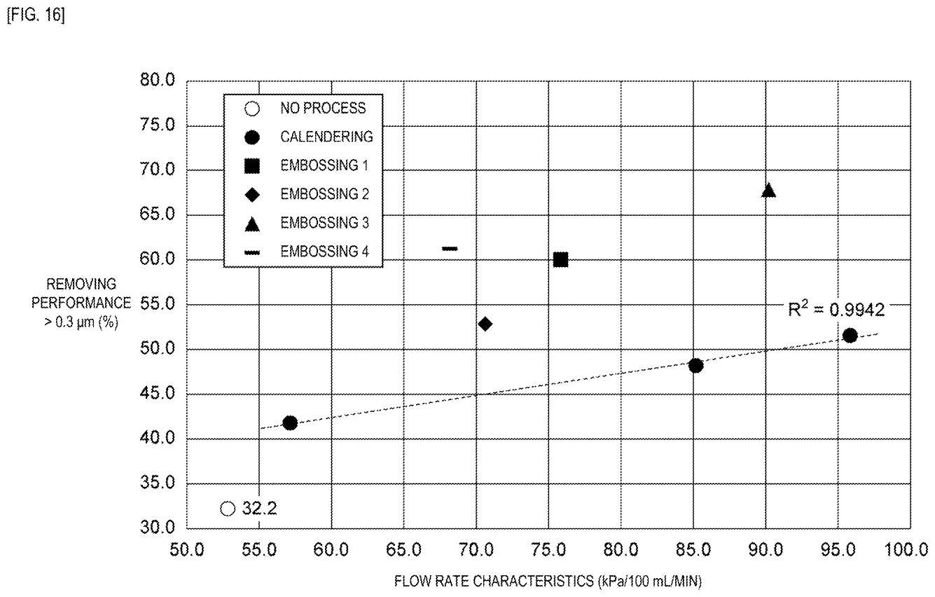

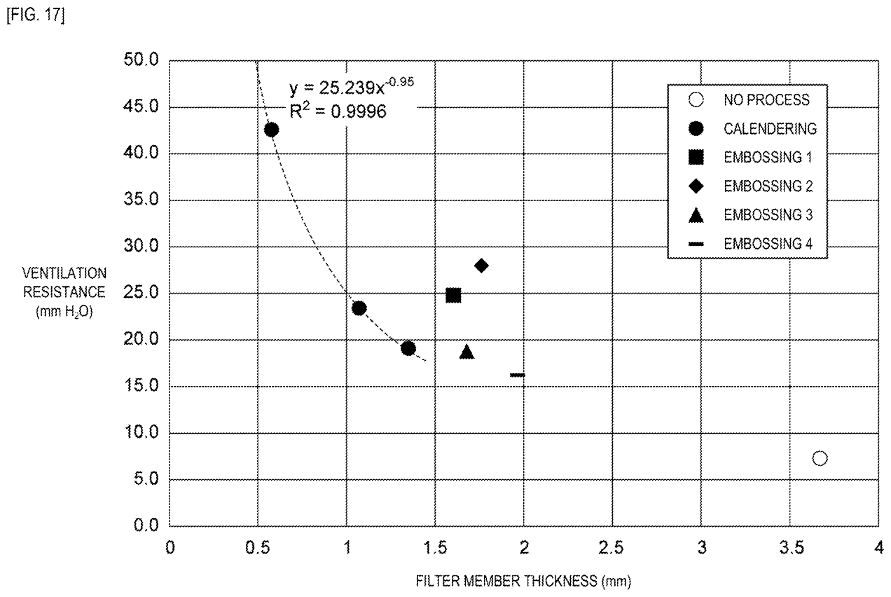

FIG. 16 illustrates the relationship between the flow rate characteristic and the removing performance. With any of the examples, removing performance higher than the approximate line based on the comparative examples was obtained. In other words, with any of the examples, high removing performance was achieved compared with the comparative examples with the same level of flow rate characteristics. FIG. 17 illustrates the relationship between the thickness of the filter member and the ventilation resistance. With embossing 1 to embossing 4, a higher ventilation resistance of the nonwoven fabric alone was achieved compared with the calendered filter member with the same thickness.

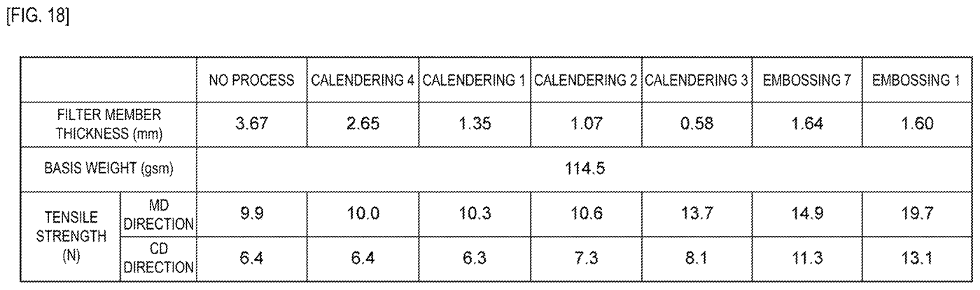

Next, a filter of the type corresponding to the second embodiment as illustrated in FIG. 9 was created. First, a filter member with “no process”, filter members with four types of calendering, and filter members with two types of embossing were prepared as illustrated in FIG. 18. Note that the filter members except for those corresponding to “calendering 4” and “embossing 7” are the same as those illustrated in FIG. 13. The calendaring 4 is the same as the calendaring 1 except for thickness. The embossing 7 is the same as the embossing 1 except for the thickness. As illustrated in FIG. 18, the embossed filter member achieved higher tensile strength than the calendered filter member.

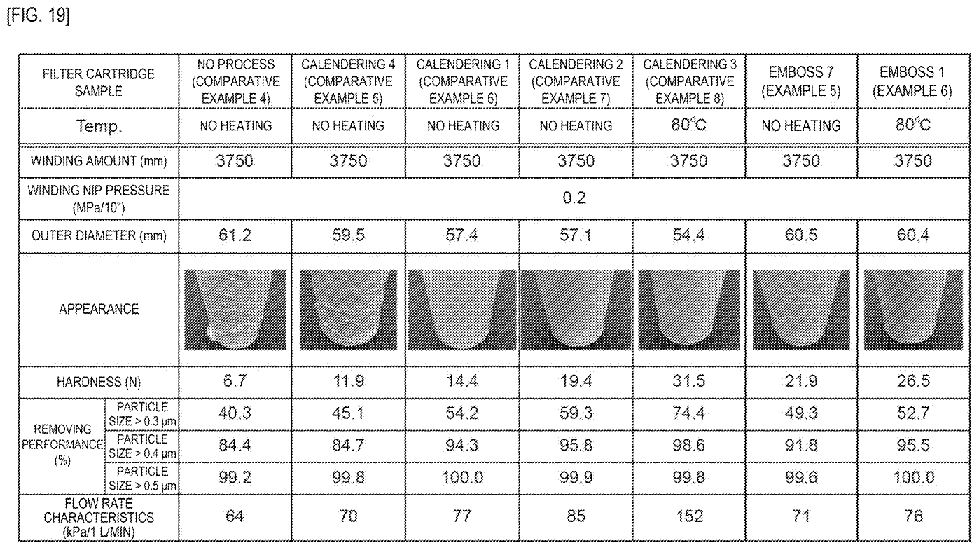

A filter of the type corresponding to the second embodiment as illustrated in FIG. 19 was created using each filter member. A filter using a filter member “no process” was defined as Comparative Example 4, filters using filter members of “calendaring 1 to calendaring 3 and calendaring 4” were defined as Comparative Examples 5 to 8, and filters using filter members of “embossing 1 and embossing 7” were defined as Examples 5 and 6. Note that a filter member having a length of 3750 mm was used in any of the comparative examples and the examples. The feed speed of the filter member was 200 (mm/min), and the nip pressure during winding was 0.2 (MPa/10 inches). The winding termination was welded by thermal welding. The diameters of these filter elements are listed in the field “outer diameter” in FIG. 19.

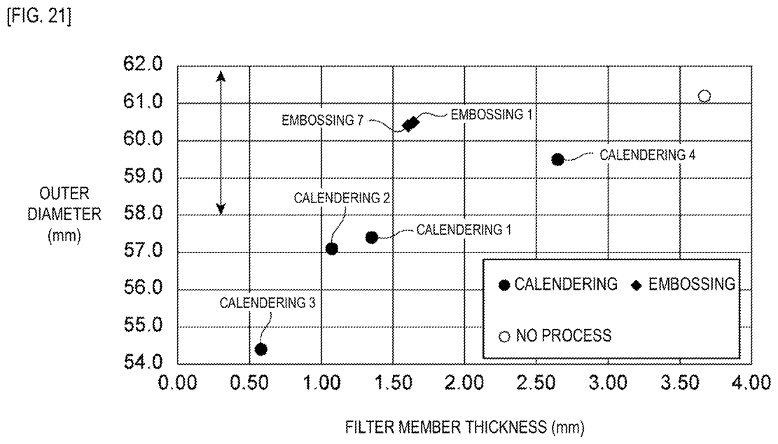

FIG. 21 illustrates the relationship between the thickness of the filter member and the outer diameter of the filter element. The filter elements with “no process”, calendering 4, embossing 7, and embossing 1 achieved the outer diameter of the target specification (58 mm to 62 mm). On the other hand, the calendering 1, calendering 2, and calendering 3 failed to achieve this.

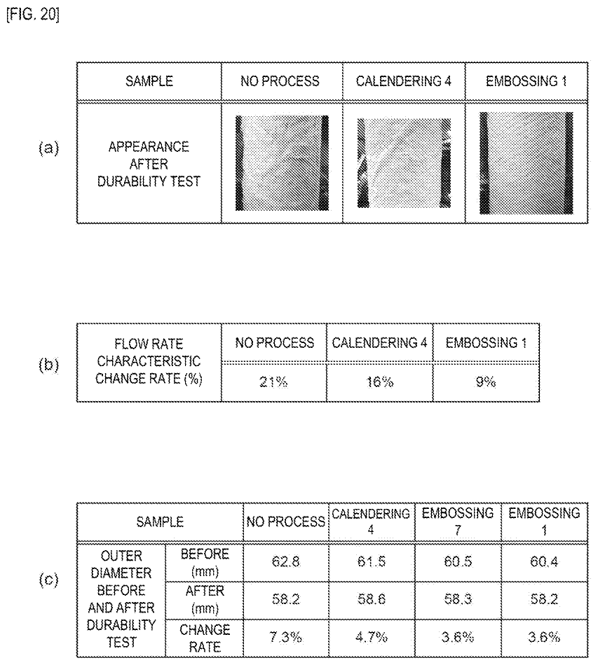

Next, the following durability test was performed in order to check the crushing of the filter element. First, a 10-inch filter cartridge provided with the filter element was set in the housing. Note that the term filter cartridge used in the description of the test content corresponds to the “filters” according to the first to the third embodiments described above. Next, 90° C. hot water was passed through the filter cartridge for 15 minutes at 0.15 MPa. Next, 25° C. tap water was passed through the filter cartridge for 5 minutes at 0.15 MPa. A liquid passage test under a high load condition was performed by repeating the cycle of passing the hot water and tap water for five times. Then, the surface condition of the filter element was observed. The “APPEARANCE” in FIG. 19 indicates the appearance before the test, and “appearance after durability test” in FIG. 20(a) indicates the result of the observation of the appearance after the test. As illustrated in FIG. 20(a), the filter element using the embossed filter member has a good appearance maintained with no collapsing or surface fraying, compared with the filter elements using the filter members with “no process” and calendering 4.

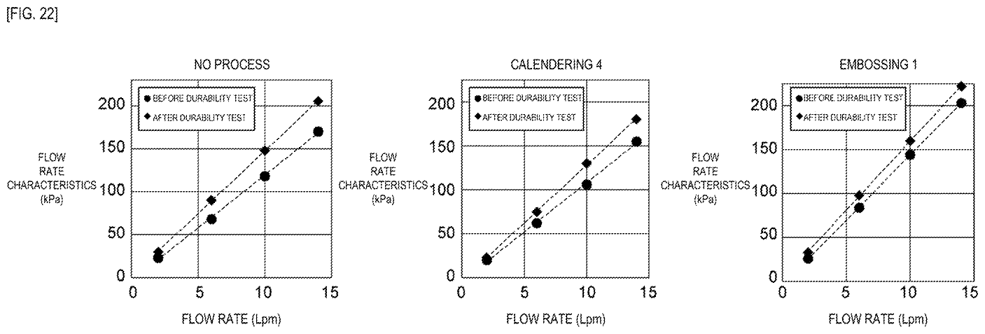

After the liquid passage under the high load condition as described above, the deformation of the filter element may affect the flow rate characteristics. In view of this, a flow rate test of comparing the states of the filter element before and after the durability test was performed. First, 25° C. tap water was passed through the filter cartridges at 2, 6, 10, and 14 L/min to obtain the liquid passing resistance as the flow rate characteristics. FIG. 22 illustrates the relationship between the flow rate and the flow rate characteristic of the filter element using each filter member. FIG. 20(b) illustrates a rate of change in flow rate characteristics at 14 L/min. The filter element with embossing 1 achieved a lower rate of change in flow rate characteristics than that achieved by the filter elements with “not process” and “calendering 4”. Note that the rate of change in the flow rate characteristics is a value obtained with the flow rate characteristics before the durability test defined as 100%, and is specifically determined by “(liquid passing resistance after durability test/liquid passing resistance before durability test)−100” (%).

Next, a test of comparing the outer diameters of the filter element before and after the durability test was performed. Here, a rate of change in the outer diameter is calculated by measuring the outer diameters of the filter element before and after the durability test. FIG. 20(c) illustrates the rate of change. Note that FIG. 20(c) also illustrates the outer diameters before and after the durability test. The filter elements using the filter members with embossing 1 and embossing 7 achieved a lower rate of change than those achieved by the other filter elements.

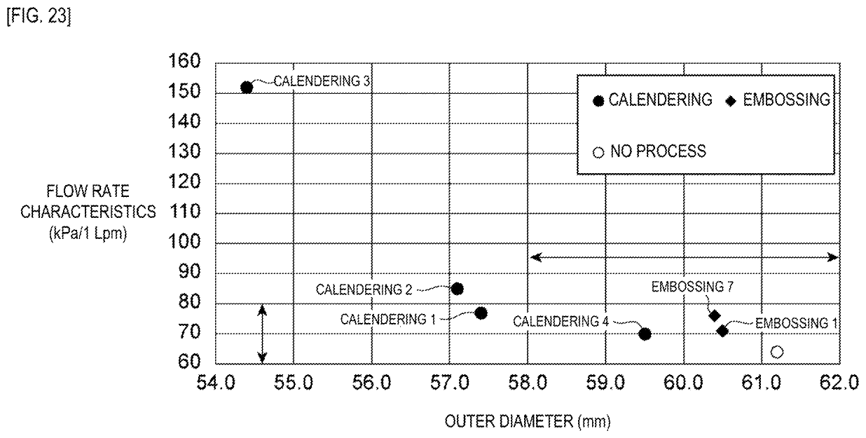

FIG. 23 illustrates the relationship between the outer diameter and the flow rate characteristics of the filter element. The filter elements with “no process”, calendering 4, embossing 1, and embossing 7 achieved tolerable differential pressure performance (differential pressure lower than 80 kPa and outer diameter of 58 to 62 mm). The filter elements with the other filter members were outside the tolerable range. Thus, the flow rate characteristics are compromised if the outer diameter of the filter element is too small.

A test for evaluating the removing performance of each filter element was performed. For the measurement of the removing performance, four steps of “(1) Preparation of 2-inch cartridge samples and setting in housing”, “(2) Hydrophilic treatment”, “(3) Measurement of flow rate characteristic (liquid passing resistance)”, and “(4) Measurement of removing performance” were performed in succession. In “(1) Preparation of 2-inch cartridge samples and setting in housing”, the filter element was first cut to be 2 inches long and assembled into a 2-inch cartridge. The cartridge was set in the housing. In “(2) Hydrophilic treatment”, a hydrophilic treatment was performed with ultrapure water filled. The outlet side in the liquid passing step was sealed, and then this state was maintained for 10 minutes under a pressure of 0.1 MPa. Then, the outlet side in the liquid passing step was opened, and the liquid was passed at 0.1 MPa for 5 minutes. In “(3) Measurement of flow rate characteristic (liquid passing resistance)”, the ultrapure water was passed at a flow rate in the range of 100 to 500 mL/min after the hydrophilic treatment, and the liquid passing resistance with a 1-L/min liquid-passing conversion value was determined from the relationship between the differential pressure and the flow rate during the passing of the ultrapure water. This liquid passing resistance was determined as the flow rate characteristic. In “(4) Measurement of removing performance”, fumed silica (OX50, available from Evonik) was added to a colloidal silica solution diluted 10-fold with ultrapure water (PL2, available from Fuso Chemical Co., Ltd.) at a concentration of 1 ppm, and thus a challenge liquid was adjusted. The challenge liquid was passed through the cartridge at a flow rate of 330 mL/min, and the filtrate was sampled after 210 seconds. The numbers of particles contained in undiluted solution and filtrate samples was measured with a particulate counter Accusizer (registered trademark) FX-Nano (available from Nihon Entegris GK), to measure the removing performance.

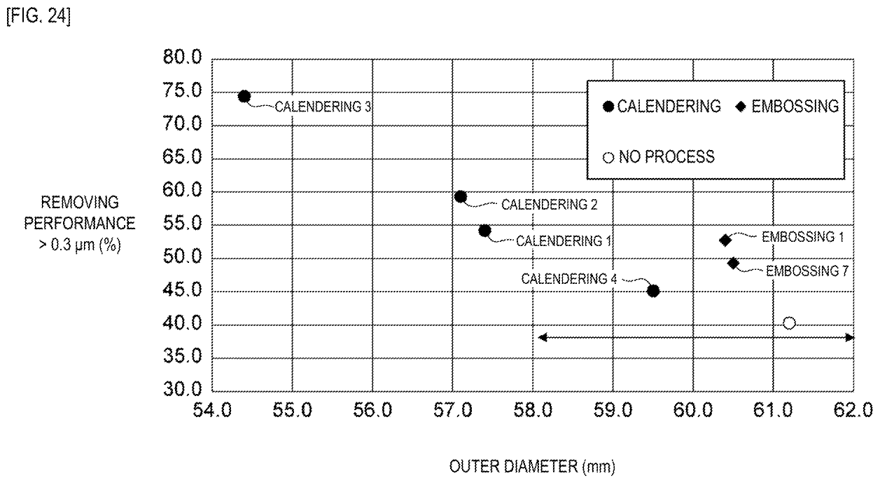

FIG. 24 illustrates the relationship between the outer diameter and the removing performance of the filter element. Of the filter elements with the outer diameter and the flow rate characteristics being in the tolerable range, the filter elements using the filter members with embossing 1 and embossing 7 achieved higher removing performance than those achieved by the filter elements using other filter members.

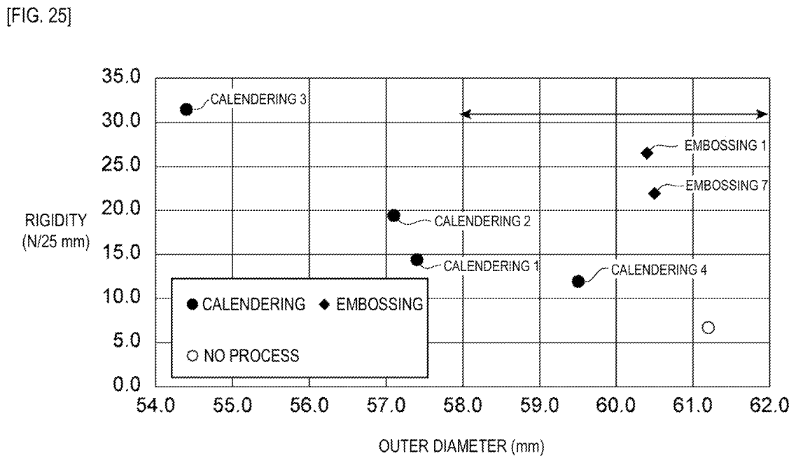

A rigidity test for the filter elements was performed. First, the filter element was cut to be 25 mm wide in the axial direction to obtain an annular sample. The samples were set with both end portions thereof, on the outer side in the radial direction, clamped by a pair of flat plates. The sample was compressed by a rigidity tester at 10 mm/min, and the stress at the point of 3 mm compression deformation was measured as the rigidity. FIG. 25 illustrates the relationship between the outer diameter and the rigidity of the filter element. Of the filter elements with the outer diameter and the flow rate characteristics being in the tolerable range, the filter elements using the filter members with embossing 1 and embossing 7 achieved higher removing performance than those achieved by the filter elements using other filter members.

1. A filter comprising a filter element having a filter member with a tubular shape disposed on an outer side of a porous tube, wherein the filter member has an embossed portion formed on a surface of the filter member.

2. The filter according to claim 1, wherein the filter member is a sheet-like member, and is wound around the porous tube.

3. The filter according to claim 2, wherein the filter element includes a wound laminated sheet of the filter member and a net-like substrate.

4. The filter according to claim 2, wherein in the filter element, the filter member is continuously laminated in a radial direction.

5. The filter according to claim 2, wherein, in the filter element, a plurality of the filter members having different ventilation resistances are laminated in the radial direction and wound.

6. The filter according to claim 2, wherein the filter member has pores.

7. The filter according to claim 1, wherein the filter member is disposed on the outer side of the porous tube, the filter member being folded into a pleated shape.
